(19) United States
(12) Patent Application Publication
(10) Pub. No.: US 2006/0202890 A1
(43) Pub. Date: Sep. 14, 2006

(54) Adaptive antenna/combiner for reception of satellite signals and associated methods

(75) Inventor: James C. Otto, West Melbourne, FL (US)

Correspondence Address: MICHAEL W. TAYLOR, P.O. BOX 3791, ORLANDO, FL, 32802-3791, US

(73) Assignee: InterDigital Technology Corporation, Wilmington, DE (US)

(21) Appl. No.: 11/340,915

(22) Filed: Jan. 27, 2006

Related U.S. Application Data
(60) Provisional application No. 60/651,725, filed on Feb. 10, 2005.

(51) Int. Cl. H01Q 21/24; H04B 1/06; H04B 7/00

(52) U.S. Cl. 342/362; 455/273; 455/277.1

(57) ABSTRACT

A communications device includes horizontally and vertically polarized antenna elements. A switching network is coupled to the antenna elements for switching signals received therefrom between first and second switching configurations. A combiner is coupled to the switching network for generating a first combined output signal having a first phase relationship based upon the first switching configuration, and for generating a second combined output signal having a second phase relationship based upon the second switching configuration. A receiver is coupled to the combiner and determines a respective signal quality of the first and second combined output signals. The receiver provides feedback to the switching network for selecting the first or second switching configuration based upon the determined signal qualities.

### RELATED APPLICATION

This application claims the benefit of U.S. Provisional Application Ser. No. 60/651,725 filed Feb. 10, 2005, the entire contents of which are incorporated herein by reference.

### FIELD OF THE INVENTION

The present invention relates to the field of satellite communication systems, and more particularly, to a satellite communications device receiving circularly polarized signals from a satellite.

### BACKGROUND OF THE INVENTION

Satellite signals are normally circularly polarized (CP), having both vertical and horizontal components. A communications device receiving circularly polarized signals from a satellite typically includes an adaptive antenna/combiner. When the communications device 20 is in a building 30, as shown in FIG. 1, and by the time the signal 42 transmitted by the satellite 40 is received, it is subjected to multipath reflections. Multipath reflections cause the satellite signal 42 to not be in the proper phase when received by the communications device 20. The communications device 20 may be a satellite radio receiving satellite radio transmissions from XM radio or Sirius, for example.

A quadrature hybrid 50 is a key component of the adaptive antenna/combiner, as illustrated in FIGS. 2a-2b and 3a-3b. In the communications device 20, the quadrature hybrid 50 functions as a signal combiner. The quadrature hybrid 50 may also be used on the transmit side. In the satellite 40, the quadrature hybrid 50 functions as a power divider.

A conventional CP transmit antenna 60 implemented with the quadrature hybrid 50 is illustrated in FIG. 2a, and corresponding vector diagrams are provided in FIG. 2b. The signal to be transmitted St is split into two components, Sv and Sh, by the quadrature hybrid 50, with phases as shown in the vector diagrams. Voltage vector Sv is transmitted via a vertically polarized antenna element 62, and voltage vector Sh is transmitted via a horizontally polarized antenna element 64. The phase of voltage vector Sv lags St by 90 degrees and the phase of voltage vector Sh lags St by 180 degrees.

A conventional CP receive antenna 70 implemented with the quadrature hybrid 50 is illustrated in FIG. 3a, and corresponding vector diagrams are provided in FIG. 3b. At the CP receive antenna 70, voltage vector Sv is received via a vertically polarized element 72 and voltage vector Sh is received via a horizontally polarized element 74. Voltage vectors Sv and Sh are combined in the quadrature hybrid 50 to produce a combined output voltage vector Sr, with phases shown in the vector diagrams. The phase of voltage vector S21 lags Sh by 90 degrees, and the phase of voltage vector S31 lags Sv by 180 degrees.

The conventional CP receive antenna 70 captures all available energy when voltage vectors Sv and Sh are properly phased. This is the case for line-of-sight signals (LOS) with no reflections (FIG. 4a). However, it is desirable to receive CP signals in environments where the LOS signal is blocked and the signals arriving at the CP receive antenna 70 include reflected components due to multipath (FIG. 4b).

In these cases voltage vectors Sv and Sh are vector sums of many reflected components each with a different magnitude, phase and angle of arrival. The phase between voltage vectors Sv and Sh is no longer fixed at 90 degrees. Consequently, a conventional CP receive antenna 70 no longer provides optimum reception.

The voltage vectors for a LOS signal, Sv and Sh, arrive in the proper phase, i.e., 90 degrees. Therefore, voltage vectors S21 and S31 add in phase to produce Sr. The voltage vectors Sv and Sh for multipath signals are vector sums of reflected components and are not in the proper phase. As a result, voltage vectors S21 and S31 do not add in phase. In this case, reception is not optimum and the value of Sr is smaller than the value of Sr for the LOS case.

To compensate reception of a CP signal subjected to multipath reflections, the adaptive antenna combiner 80 may include a continuous phase shifter 82, as shown in FIG. 5a. The adaptive antenna/combiner (AAC) 80 is connected to a satellite receiver 90. The signal Sh from the horizontally polarized antenna element 74 is applied directly to the quadrature hybrid 50. The signal Sv from the vertically polarized antenna element 72 is applied to a variable phase shifter 82 that adjusts the phase of its output Svc relative to Sv. The output Svc of the phase shifter 82 is applied to the quadrature hybrid 50.

In the quadrature hybrid 50, Sh and Svc are combined at an optimum phase to produce a combined output signal Sr. The combined output signal Sr is applied to a low noise amplifier 84, which is typically collocated with the adaptive antenna/combiner 80. The output from the low noise amplifier 84 is sent to the satellite receiver 90.

A phase shift controller 86 searches for the best phase at which to combine Sh and Svc. A search includes shifting the phase of Svc in N increments. At each shift, a sample of the signal quality is obtained from the satellite receiver 90. After collecting N samples, the phase shift corresponding to the best signal quality is selected.

This is illustrated by the example vectors shown in FIG. 5b. The signals Sv, Sh received by the horizontally and vertically polarized antenna elements 74, 72 do not have the same phase relationship as initially transmitted. For these signals, the received signals Sv and Sh do not combine for optimum reception.

For the adaptive antenna/combiner 80, the voltage vector Sh is shifted 90 degrees in the quadrature hybrid 50 to become S21. The voltage vector Sv is shifted 135 degrees by the variable phase shifter 82 to become Svc.

The voltage vector Svc is then shifted 180 degrees in the quadrature hybrid 50 to become S31. Voltage vectors S21 and S31 combine in phase to produce a combined output voltage vector Sr. The output voltage vector Sr is maximized at a phase shift of 135 degrees between Sv and Svc. A disadvantage of the continuous phase shifter 82 is that it is expensive, and it is often lossy, which results in a degraded performance.

### SUMMARY OF THE INVENTION

In view of the foregoing background, it is therefore an object of the present invention to provide a low cost adaptive antenna/combiner for receiving circularly polarized signals while not significantly degrading performance.

This and other objects, features, and advantages in accordance with the present invention are provided by a communications device comprising a horizontally polarized antenna element, a vertically polarized antenna element and a switching network coupled to the horizontally polarized antenna element and to the vertically polarized antenna element for switching signals received therefrom between first and second switching configurations.

A combiner is coupled to the switching network for generating a first combined output signal having a first phase relationship based upon the first switching configuration, and for generating a second combined output signal having a second phase relationship based upon the second switching configuration. A receiver is coupled to the combiner and determines a respective signal quality of the first and second combined output signals.

The receiver provides feedback to the switching network for selecting the first or second switching configuration based upon the determined signal qualities. The determined signal qualities may be signal strength, bit error rate or signal-to-interference ratio, for example.

The switching network may comprise first and second switches and a switch controller. The first switch is coupled to the horizontally polarized antenna, and the second switch is coupled to the vertically polarized antenna. The switch controller is coupled to the first and second switches for placing the first and second switches in the first or second switching configuration.

The adaptive antenna/combiner discussed in the background section requires a continuous phase shifter. This component is often expensive and may be lossy resulting in degraded performance. The switching network in accordance with the present invention advantageously eliminates the need for the phase shifter. This results in a practical and low cost adaptive antenna/combiner while not significantly degrading performance.

Another aspect of the invention is directed to a method for receiving circularly polarized signals using a communications device as defined above. The method comprises receiving signals at the horizontally and vertically polarized antenna elements, and operating the switching network for switching the received signals between first and second switching configurations.

The method may further comprise generating at the combiner a first combined output signal having a first phase relationship based upon the first switching configuration, and generating a second combined output signal having a second phase relationship based upon the second switching configuration. A respective signal quality of the first and second combined output signals is determined at the receiver, feedback to the switching network is provided for selecting the first or second switching configuration based upon the determined signal qualities.

### BRIEF DESCRIPTION OF THE DRAWINGS

FIG. 1 is a block diagram of a communications device in a building receiving multipath signals from a satellite in accordance with the prior art.

FIG. 2a is a block diagram of a modeled circularly polarized transmit antenna in accordance with the prior art.

FIG. 2b illustrates vector diagrams corresponding to the modeled circularly polarized transmit antenna shown in FIG. 2a.

FIG. 3a is a block diagram of a modeled circularly polarized receive antenna in accordance with the prior art.

FIG. 3b illustrates vector diagrams corresponding to the modeled circularly polarized receive antenna shown in FIG. 3a.

FIG. 4a illustrates vector diagrams for a line-of-sight signal received by a circularly polarized receive antenna in accordance with the prior art.

FIG. 4b illustrates vector diagrams for a multipath signal received by a circularly polarized receive antenna in accordance with the prior art.

FIG. 5a is a block diagram of an adaptive antenna/combiner coupled to a satellite receiver in accordance with the prior art.

FIG. 5b illustrates vector diagrams corresponding to the adaptive antenna/combiner shown in FIG. 5a.

FIG. 6 is a block diagram of a communications device in accordance with the present invention.

FIG. 7 is a more detailed block diagram of the switching network shown in FIG. 6.

FIG. 8a illustrates vector diagrams of the first combined output signal having a first phase relationship based upon a first switching configuration for the switching network shown in FIG. 7.

FIG. 8b illustrates vector diagrams of the second combined output signal having a second phase relationship based upon a second switching configuration for the switching network shown in FIG. 7.

FIG. 9a is a front view of one embodiment of an adaptive antenna/combiner in accordance with the present invention.

FIG. 9b is a side view of the adaptive antenna/combiner shown in FIG. 9a.

FIG. 10 is a graph illustrating performance of the adaptive antenna/combiner in accordance with the present invention.

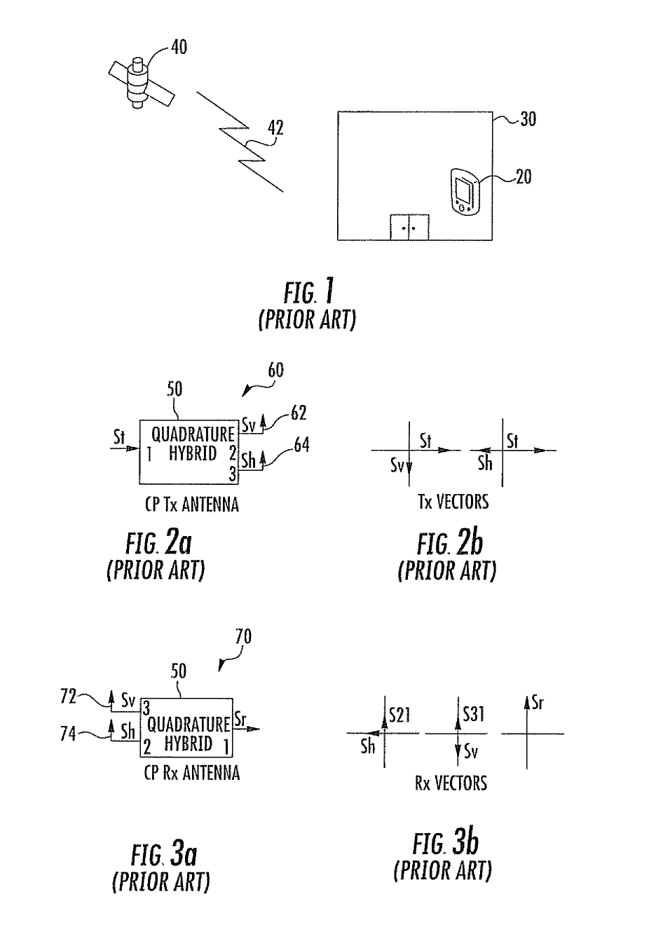

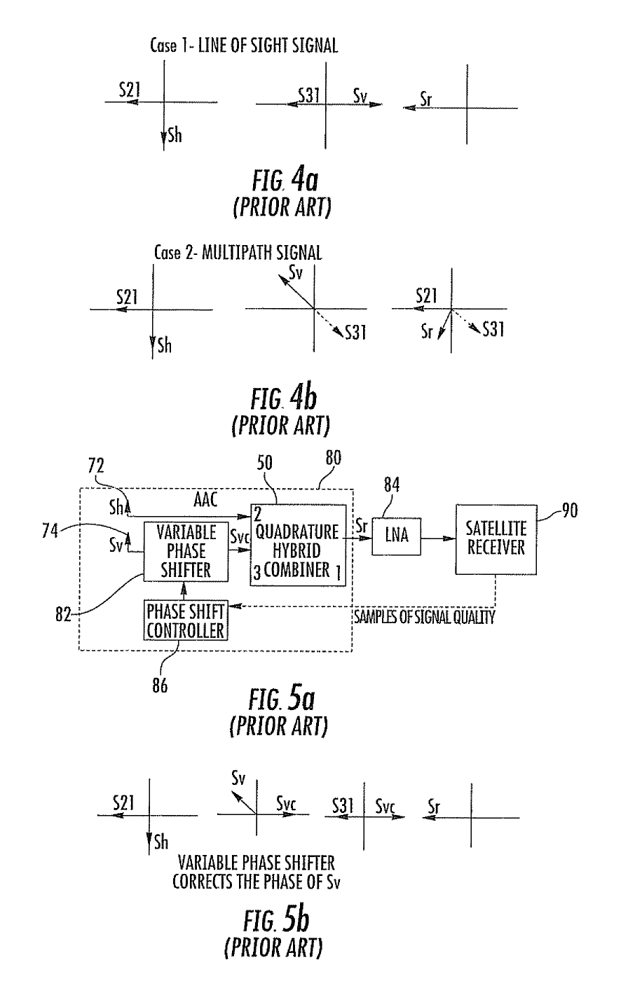

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

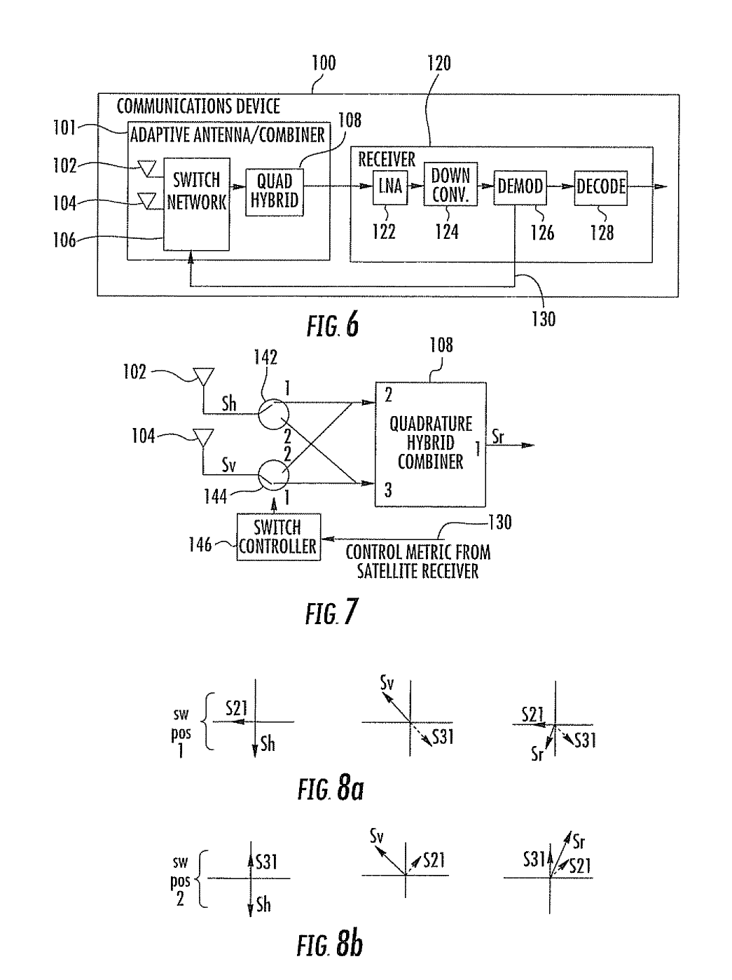

A communications device 100 in accordance with the present invention will now be discussed in reference to FIGS. 6 and 7. The communications device 100 is intended to receive circularly polarized (CP) signals, as typically transmitted by a satellite 40. Nonetheless, the communications device 100 is not limited to reception of satellite signals. The receive signals may be from WIFI/MIMO or other applications, as readily appreciated by those skilled in the art.

The circularly polarized signal 42 received by the communications device 100 propagates through a multipath environment. The initial phase and amplitude relationship between horizontal and vertical components of the circularly polarized signal 42 are modified such that a receiver with a conventional CP antenna 70 experiences degraded performance.

The communications device 100 includes a switched adaptive antenna/combiner 101, and receives the circularly polarized signals 42 using separate horizontal and vertical antenna elements 102 and 104. A switching network 106 is coupled to the horizontally polarized antenna element 102 and to the vertically polarized antenna element 104 for switching received signals between first and second switching configurations.

A combiner 108 is coupled to the switching network for generating a first combined output signal having a first phase relationship based upon the first switching configuration, and for generating a second combined output signal having a second phase relationship based upon the second switching configuration.

A receiver 120 is coupled to the combiner 108 and determines a respective signal quality of the first and second combined output signals. The may be performed by the demodulator 126, for example, and provides feedback 130 to the switching network 106 for selecting the first or second switching configuration based upon the determined signal qualities.

More particularly, one embodiment of the switching network 106 comprises a first switch 142 coupled to the horizontally polarized antenna 102, and a second switch 144 coupled to the vertically polarized antenna 104. A switch controller 146 is coupled to the first and second switches 142, 144 for placing the first and second switches in the first or second switching configuration. The switch controller 146 selects the best switch position based on signal quality samples provided by the demodulator 126 within the receiver 120.

The adaptive antenna/combiner 70 discussed in the background section requires a continuous phase shifter 72. This component is often expensive and may be lossy resulting in degraded performance. The switched adaptive antenna/combiner 101 in accordance with the present invention advantageously eliminates the need for the phase shifter 72. This results in a practical and low cost adaptive antenna/combiner 100 while not significantly degrading performance.

The illustrated switched adaptive antenna/combiner 101 includes two single pole double throw (SPDT) switches 142, 144 inserted between the horizontal and vertical antenna elements 102, 104 and the quadrature hybrid combiner 108. The switches 142, 144 are controlled by the switch controller 146. Instead of searching N possible phase relationships between the received signal Sh and Sr, the switched AAC 101 searches only 2 phases.

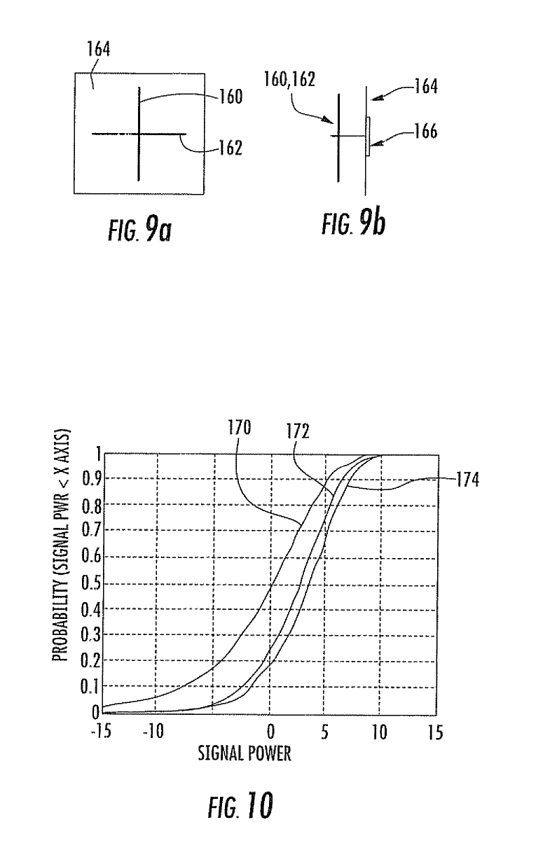

The switch controller 146 operates the two switches 142, 144 so that for switch position 1, the received signal Sh from the horizontal antenna 102 is applied to port 2 of the quadrature hybrid combiner 108. The received signal Sv from the vertical antenna 104 is applied to port 3 of the quadrature hybrid combiner 108. Vector diagrams for switch position 1 are shown in FIG. 8a.

The switch controller 146 operates the two switches 142, 144 so that for switch position 2, the received signal Sh from the horizontal antenna 102 is applied to port 3 of the quadrature combiner 108. The received signal Sv from the vertical antenna 104 is applied to port 2 of the quadrature combiner 108. Vector diagrams for switch position 2 are shown in FIG. 8b.

The switch controller 146 selects switch position 1 or 2 based on feedback 130 from the receiver 120. For each decision, the switch controller 146 selects switch position 1 and obtains a sample of signal quality Sr1. The switch controller 146 then selects switch position 2 and obtains a second sample of signal quality Sr2. The switch controller 146 then sets the switches 142, 144 to the position corresponding to the best signal quality and waits until time for the next decision.

For switch position 1, voltage vectors S21 and S31 add to produce a small value for Sr, as shown in FIG. 8a. For switch position 2, voltage vectors S21 and S31 add to produce a larger value for Sr, as shown in FIG. 10b. In this example, switch position 2 would be selected.

Since only 2 phase relationships are searched by the adaptive antenna/combiner 101, performance may be less than suboptimal as compared to the adaptive antenna/combiner 70 with the continuous phase shifter 72. However, the performance difference between a switched AAC 101 and a continuous AAC 70 is less than one would intuitively expect.

At the receiver 120, the output of the switched adaptive antenna/combiner 101 is applied to a LNA 122, a down-converter 124, the demodulator 126 and a decoder 128. The demodulator 126 provides samples of the signal quality to the switch controller 146. These may be samples of signal strength, bit error rate or signal-to-interference ratio. Many existing radios already provide these signals.

The switch controller 146 periodically updates the switch position as follows: first a sample of the signal quality for the current position is stored. Next, the switch position is changed and a second sample is obtained. Finally, the position corresponding to best signal quality is chosen.

One embodiment of a physical implementation of the adaptive antenna/combiner 101 includes a pair of crossed dipoles 160 and 162, as shown in FIGS. 9a and 9b. Behind the dipoles 160 and 162, a reflector 164 provides a directed beam. The signals received by the dipoles 160 and 162 are combined in a combiner/LNA module 166 located behind the reflector 164. The adaptive antenna/combiner 101 is not limited to this particular embodiment. Many other embodiments are possible, as readily appreciated by those skilled in the art.

Performance of the switched adaptive antenna/combiner 101 will now be discussed in reference to FIG. 10. A MATLAB simulation has been used to quantify relative antenna performance. The program generates signals that are typical for an indoor multipath rich environment.

In the simulation, two sets of samples are generated: one for the horizontal antenna element 102 and another for the horizontal antenna element 104. The signals are applied to three antenna/combiner types. A first type is a conventional antenna/combiner in which the input vectors are added at a fixed phase relationship (90 degrees). A second type is an ideal case in which the input vectors are added at the phase that yields a maximum output signal. A third type is a 1-bit switched adaptive antenna/combiner 101 that samples 2 phase relationships and selects the one which yields the larger output signal.

The cumulative distribution functions for each antenna/combiner type is provided in FIG. 10. The conventional antenna/combiner (first type) is represented by line 170. The ideal antenna/combiner (second type) that adds the input vectors at a fixed phase relationship (90 degrees) is represented by line 172. The switched adaptive antenna/combiner 101 is represented by line 174. The ideal antenna/combiner represented by line 172 is only a few 10^{ths} of a db better than the much simpler switched antenna/combiner 101 represented by line 174.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A communications device comprising:
a horizontally polarized antenna element;
a vertically polarized antenna element;
a switching network coupled to said horizontally polarized antenna element and to said vertically polarized antenna element for switching signals received therefrom between first and second switching configurations;
a combiner coupled to said switching network for generating a first combined output signal having a first phase relationship based upon the first switching configuration, and for generating a second combined output signal having a second phase relationship based upon the second switching configuration; and
a receiver coupled to said combiner and determining a respective signal quality of the first and second combined output signals, said receiver providing feedback to said switching network for selecting the first or second switching configuration based upon the determined signal qualities.

2. A communications device according to claim 1 wherein said switching network comprises:
a first switch coupled to said horizontally polarized antenna;
a second switch coupled to said vertically polarized antenna; and
a switch controller coupled to said first and second switches for placing said first and second switches in the first or second switching configuration.

3. A communications device according to claim 2 wherein each switch comprises a single pole double through switch.

4. A communications device according to claim 1 wherein said combiner has first and second inputs coupled to outputs of said switching network.

5. A communications device according to claim 1 wherein said combiner comprises a quadrature hybrid combiner.

6. A communications device according to claim 1 wherein the determined signal qualities comprise at least one of signal strength, bit error rate and signal-to-interference ratio.

7. A communications device according to claim 1 wherein the received signals from said horizontally and vertically polarized antenna elements correspond to circularly polarized signals.

8. A communications device comprising:
a horizontally polarized antenna element for receiving a circularly polarized signal;
a first switch coupled to said horizontally polarized antenna;
a vertically polarized antenna element for receiving the circularly polarized signal;
a second switch coupled to said vertically polarized antenna;
a switch controller coupled to said first and second switches for switching the circularly polarized signals received by said first and second switches between first and second switching configurations;
a combiner coupled to said first and second switches for generating a first combined output signal having a first phase relationship based upon the first switching configuration, and for generating a second combined output signal having a second phase relationship based upon the second switching configuration.

9. A communications device according to claim 8 further comprising a receiver coupled to said combiner, said receiver for determining a respective signal quality of the first and second combined output signals, and providing feedback to said switch controller for selecting the first or second switching configuration based upon the determined signal qualities.

10. A communications device according to claim 8 wherein each switch comprises a single pole double through switch.

11. A communications device according to claim 8 wherein said combiner has first and second inputs coupled to outputs of said first and second switches.

12. A communications device according to claim 8 wherein said combiner comprises a quadrature hybrid combiner.

13. A communications device according to claim 8 wherein the determined signal qualities comprise at least one of signal strength, bit error rate and signal-to-interference ratio.

14. A method for receiving circularly polarized signals using a communications device comprising horizontally and vertically polarized antenna elements; a switching network coupled to the horizontally and vertically polarized antenna elements;
a combiner coupled to the switching network; and a receiver coupled to the combiner, the method comprising:
receiving signals at the horizontally and vertically polarized antenna elements;
operating the switching network for switching the received signals between first and second switching configurations;
generating at the combiner a first combined output signal having a first phase relationship based upon the first switching configuration, and generating a second combined output signal having a second phase relationship based upon the second switching configuration;
determining at the receiver a respective signal quality of the first and second combined output signals; and
providing feedback to the switching network for selecting the first or second switching configuration based upon the determined signal qualities.

15. A method according to claim 14 wherein the switching network comprises a first switch coupled to the horizontally polarized antenna, a second switch coupled to the vertically polarized antenna, and a switch controller coupled to the first and second switches for placing the first and second switches in the first or second switching configuration.

16. A method according to claim 15 wherein each switch comprises a single pole double through switch.

17. A method according to claim 14 wherein the combiner has first and second inputs coupled to outputs of the switching network.

18. A method according to claim 14 wherein the combiner comprises a quadrature hybrid combiner.

19. A method according to claim 14 wherein the determined signal qualities comprise at least one of signal strength, bit error rate and signal-to-interference ratio.
